(19) United States
(12) Patent Application Publication
(10) Pub. No.: US 2006/0200666 A1
(43) Pub. Date: Sep. 7, 2006

(54) Methods, communication networks, and computer program products for monitoring communications of a network device using a secure digital certificate

(76) Inventor: Samuel Bailey JR., Atlanta, GA (US)

Correspondence Address: MYERS BIGEL SIBLEY & SAJOVEC, P.A., P.O. BOX 37428, RALEIGH, NC, 27627, US

(21) Appl. No.: 11/069,077

(22) Filed: Mar. 1, 2005

(51) Int. Cl. H04L 9/00

(52) U.S. Cl. 713/168

(57) ABSTRACT

A communication network is operated by storing a digital certificate on a subject device. A communication session is established between the subject device and another device across a communication network. The communication session incorporates the digital certificate in at least one message between the subject device and the other device. Authorization is received from a legal authority to monitor communications associated with the subject device. The communication network is configured to monitor communications thereon associated with the digital certificate responsive to receiving authorization from the legal authority.

### FIELD OF THE INVENTION

The present invention relates to communication networks and methods of operating the same, and, more particularly, to monitoring communications of a network device.

### BACKGROUND OF THE INVENTION

Communications networks are widely used for nationwide and worldwide communication of voice, multimedia and/or data. As used herein, communications networks include public communications networks, such as the Public Switched Telephone Network (PSTN), terrestrial and/or satellite cellular networks and/or the Internet.

Although network operators and service providers may be concerned with their customers' security and/or privacy, the public also has an interest in using such networks as a tool against criminals. In this regard, congress has passed the Communications Assistance for Law Enforcement Act (CALEA), which sets forth requirements for network operators/service providers to follow in designing their networks/services to facilitate lawfully authorized surveillance by the appropriate authorities. CALEA does not expand law enforcement's authority to conduct certain types of surveillances or investigations, but instead seeks to ensure that once law enforcement obtains the legal authority to conduct a surveillance or investigation that the communication networks have the technological capability to fulfill their statutory obligation to assist law enforcement.

Historically, monitoring communications on a wireline may have involved installing a tap on the line to record the communications taking place thereon. Unfortunately, such taps are not applicable to digital, packet-based technologies used in, for example, wireless phones (e.g., mobile terminals) and/or Internet Protocol (IP) phones.

### SUMMARY OF THE INVENTION

According to some embodiments of the present invention, a communication network is operated by storing a digital certificate on a subject device. A communication session is established between the subject device and another device across a communication network. The communication session incorporates the digital certificate in at least one message between the subject device and the other device. Authorization is received from a legal authority to monitor communications associated with the subject device. The communication network is configured to monitor communications thereon associated with the digital certificate responsive to receiving authorization from the legal authority.

In other embodiments of the present invention, the monitored communications are provided to a monitoring agency.

In still other embodiments of the present invention, providing the monitored communications comprises encrypting the monitored communications and providing the encrypted, monitored communications to the monitoring agency via the World Wide Web.

In still other embodiments of the present invention, the communication network is configured to cease monitoring communications thereon associated with the digital certificate. The legal authority is informed that the monitored communications have been provided to the monitoring agency.

In still other embodiments of the present invention, the digital certificate is a first digital certificate and receiving authorization from the legal authority comprises receiving an order to monitor communications associated with the subject device, wherein the order comprises a second digital certificate. The digital certificate is decoded to determine if the order was sent from the legal authority.

In still other embodiments of the present invention, configuring the communication network comprises configuring the communication network to monitor communications thereon associated with the digital certificate if the order is determined to have been sent from the legal authority.

In still other embodiments of the present invention, the subject device comprises a mobile terminal or an Internet Protocol (IP) phone.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention;

FIG. 2 illustrates a data processing system that may be used to implement various data processing systems of the communication network of FIG. 1 in accordance with some embodiments of the present invention; and

FIGS. 3 and 4 are flowcharts that illustrate operations of monitoring communications of a network device using a secure digital certificate in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Embodiments of the present invention are described hereafter in the context of processing a message. It will be understood that the term “message” means a unit of information and/or a block of data that may be transmitted electronically as a whole or via segments from one device to another. Accordingly, as used herein, the term “message” may encompass such terms of art as “frame” and/or “packet,” which may also be used to refer to a unit of transmission.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

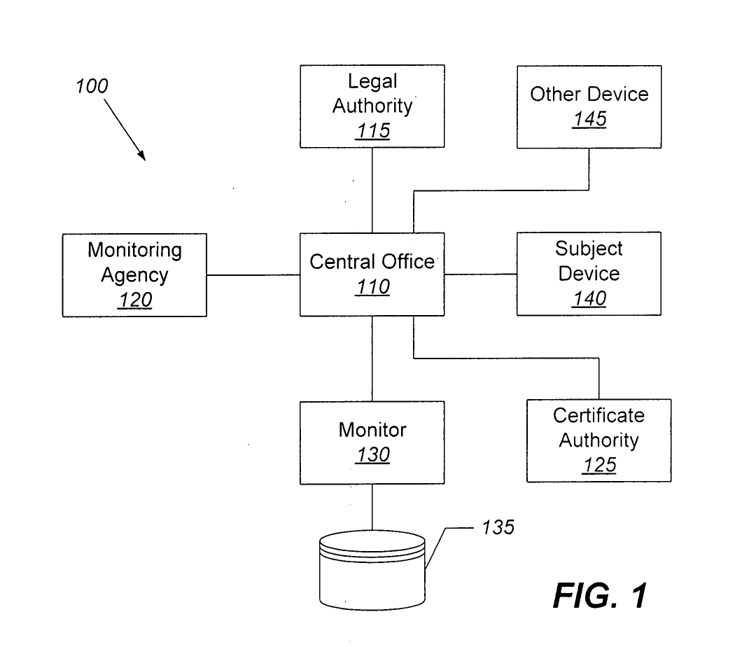

Referring now to FIG. 1, an exemplary network architecture 100 for monitoring communications of a network device using a secure digital certificate, in accordance with some embodiments of the invention, comprises a central office 110, a legal authority data processing system 115, a monitoring agency data processing system 120, a certificate authority data processing system 125, a monitor data processing system 130, a database 135, a subject device 140, and another device 145, which are configured as shown. The various elements of the network 100 may be connected by a global network, such as the Internet, public switched telephone network (PSTN), or other publicly accessible network. Various elements of the network may be interconnected by a wide area network, a local area network, an Intranet, and/or other private network, which may not accessible by the general public. Thus, the network 100 may represent a combination of public and private networks or a virtual private network (VPN).

The central office 110 is a telecommunications office that includes switching equipment for terminating subscriber home and business lines. Calls made on these lines may be switched locally or may be switched to other toll or tandem switching offices. The legal authority data processing system 115 may represent a data processing system associated with one or more court systems, for example, that may authorize surveillance of one or more network edge devices, such as the subject device 140. The monitoring agency data processing system 120 may represent a data processing system that is associated with one or more law enforcement agencies, such as, for example, the Federal Bureau of Investigation (FBI), a State Bureau of Investigation (SBI), a state or local police department, or the like.

The monitor data processing system 130 and database 135 may be configured to facilitate monitoring of communications involving a subject device 140, for example, in response to an authorization received from the legal authority 115. For example, the monitor data processing system 130 may configure the central office 110 to monitor communications of a subject device 140 for a particular time period or when the subject device communicates with a particular other device 145. The monitor data processing system 130 may be connected to the central office via a network or functionality of the monitor data processing system 130 may be incorporated into the central office in accordance with various embodiments of the present invention.

The certificate authority data processing system 125 may be used to obtain digital certificates that are used by the monitor data processing system 130, the legal authority data processing system 115, and the subject device 140 in their communications in the network 100. More specifically, a digital certificate is an attachment to an electronic message that can be used for security purposes. A digital certificate may be used, for example, to verify that a user that sends a message is who he or she claims to be. A digital certificate may be decoded using the public key of the certificate authority and typically contains the public key of the device to which the digital certificate was issued along with other identification information. Use of digital certificates to monitor communications of the subject device 140 will be described in more detail hereafter.

The central office 110 may be connected to many network devices, such as the subject device 140 and the other device 145. For purposes of illustration, the subject device 140 may be a mobile terminal and/or an Internet Protocol (IP) phone. Advantageously, embodiments of the present invention may allow monitoring or surveillance of communications via a device, such as a mobile terminal and/or an phone, which uses digital messages or packets to communicate. Thus, the subject device 140 may be connected to the central office 110 via one or more base stations in the case of a mobile terminal or via a softswitch and/or trunk gateway if the subject device 140 is an IP phone. The other device 145 may represent any type of network device that communicates with the subject device 140.

Although FIG. 1 illustrates an exemplary communication network, it will be understood that the present invention is not limited to such configurations, but is intended to encompass any configuration capable of carrying out the operations described herein.

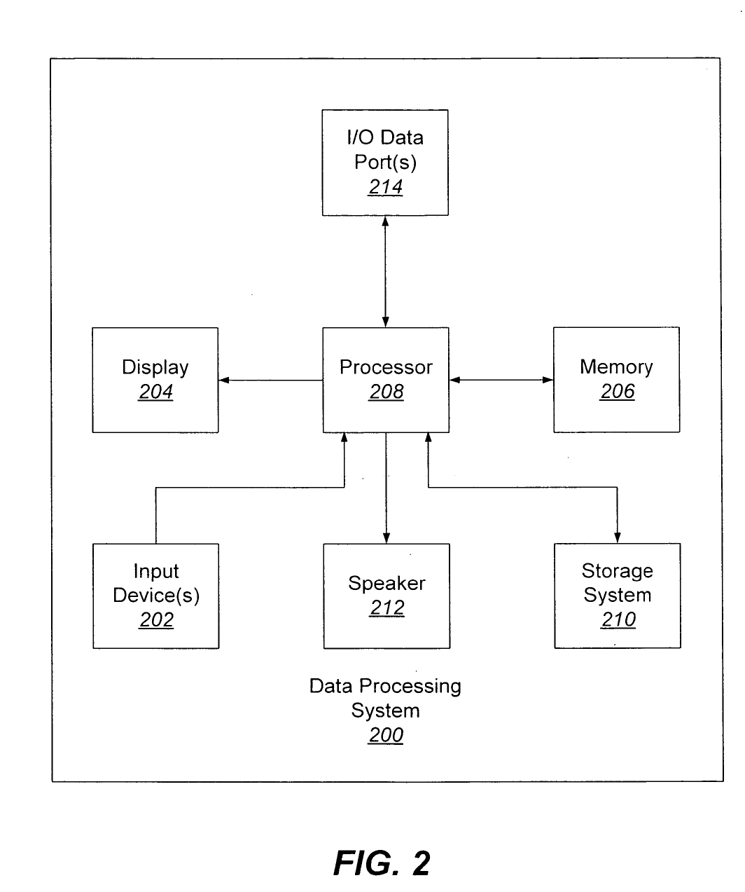

Referring now to FIG. 2, a data processing system 200 that may be used to implement the legal authority data processing system 115, the monitoring agency data processing system 120, and/or the monitor data processing system 130 of FIG. 1, in accordance with some embodiments of the present invention, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components such as those used in many conventional computing devices, which may be configured to operate as described herein.

Computer program code for carrying out operations of data processing systems discussed above with respect to FIGS. 1 and 2 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

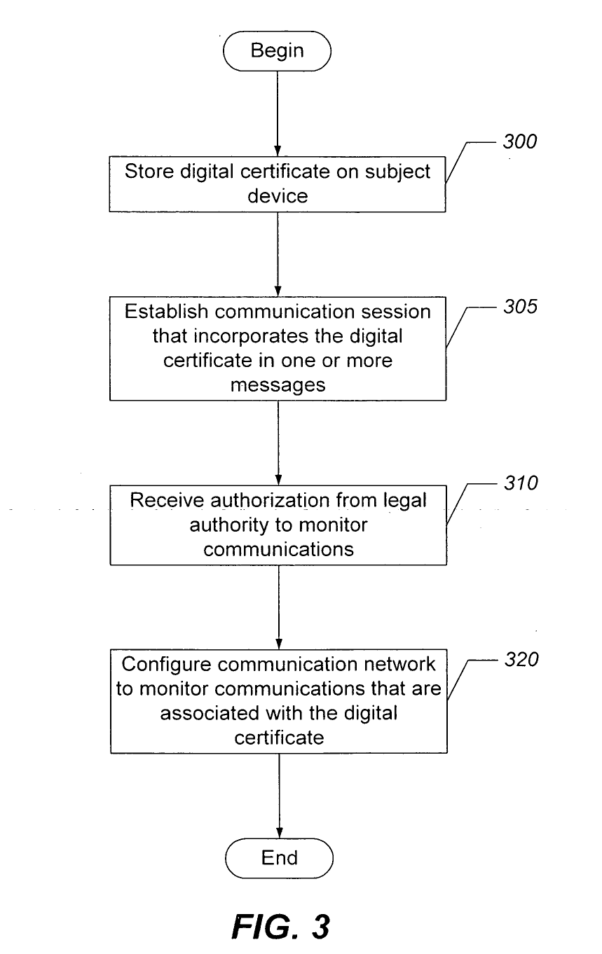

Exemplary operations for monitoring communications of a network device using a secure digital certificate will now be described with reference to FIGS. 3 and 1. Operations begin at block 300 where a digital certificate is stored on the subject device(s) 140. To facilitate monitoring of communications on the network 100, the monitor data processing system 130 configures the switch to monitor communications originating from a particular device. To ensure that the correct device is being monitored, all mobile terminals, IP phones, and the like are configured with a digital certificate obtained from the certificate authority data processing system 125 when service is established on the network 100. The monitor data processing system 130 stores information associated with each subject device 140 that may be served by the network 100, such as the public and private keys, in the database 135.

A subject device 140 may establish a communication session with another device 145 at block 305. The subject device 140 incorporates the digital certificate in one or more of the communication session messages. If the owner of the subject device 140 is the target of an investigation, then a legal authority (e.g., court) data processing system 115 may send an authorization order to the monitor data processing system 130 to monitor the communications of the subject device 140 at block 310. In some embodiments of the present invention, to ensure that the authorization order to monitor communications associated with a particular device was sent from an actual legal authority, the legal authority data processing system 115 may include a digital certificate obtained from the certificate authority data processing system 125, which may be decoded at the monitor data processing system 130 using the public key of the certificate authority 125. The public key of the legal authority data processing system 115 may be obtained along with the other identification information associated with the legal authority data processing system 115 to verify that the authorization order was sent from a valid legal authority, e.g., a court. Note that in some embodiments of the present invention, the authorization order from the legal authority to monitor a particular subject device 140 may not be sent electronically to the monitor data processing system 130, but may be a written document that is provided to the operator of the monitor data processing system 130. The operator of the monitor data processing system 130 may then initialize monitoring of communications associated with the subject device 140 upon being presented with a valid authorization order from the legal authority as described hereafter.

In response to receiving a valid authorization from the legal authority data processing system 115 to monitor the communications of the subject device 140, the monitor data processing system 130 may configure the central office 110 to monitor communications that are associated with the digital certificate that has been stored on the subject device at block 300. Advantageously, because the digital certificate assigned to the subject device 140 is unique, the communications originating and terminating at the subject device 140 can be monitored with greater confidence that the correct communications are being surveiled in accordance with the authorization of the legal authority.

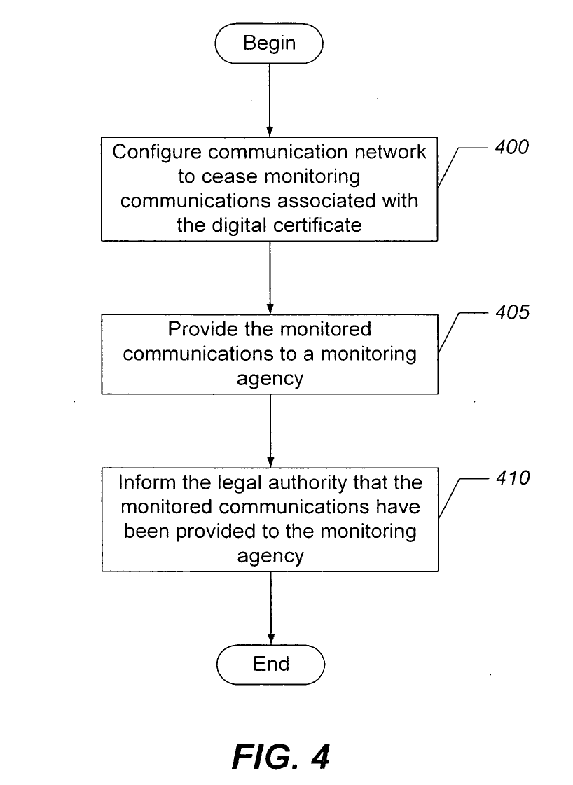

Referring to FIG. 4, in accordance with further embodiments of the present invention, the monitor data processing system 130 may configure the central office 110 to cease monitoring communications associated with the digital certificate assigned to the subject device 140 at block 400. The monitor data processing system 130 may provide the monitored communications to the monitoring agency data processing system 120 at block 405. To facilitate distribution of the monitored communications to multiple parties within the monitoring agency or to multiple monitoring agencies, the monitor data processing system 130 may encrypt the monitored communications and provide the encrypted, monitored communications to one or more monitoring agency data processing systems 120 via the World Wide Web. At block 410, the monitor data processing system 130 may inform the legal authority data processing system 115 that the monitored communications have been provided to the monitoring agency data processing system 120 to provide a status of the surveillance to the legal authority.

The flowchart of FIGS. 3 and 4 illustrate the architecture, functionality, and operations of some embodiments of methods, systems, and computer program products for monitoring communications of a network device using a secure digital certificate. In this regard, each block represents a module, segment, or portion of code, which comprises one or more executable instructions for implementing the specified logical function(s). It should also be noted that in other implementations, the function(s) noted in the blocks may occur out of the order noted in FIGS. 3 and 4. For example, two blocks shown in succession may, in fact, be executed substantially concurrently or the blocks may sometimes be executed in the reverse order, depending on the functionality involved.

Advantageously, embodiments of the present invention may allow network operators and telecommunication service providers to comply with the statutory requirements of CALEA so as to enable law enforcement and intelligence agencies to monitor communications of suspected terrorists, enemies of the state, or other suspected criminals that may use newer technologies, such as wireless communications and/or voice over Internet Protocol (VoIP).

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a communication network, comprising:
storing a digital certificate on a subject device;
establishing a communication session between the subject device and another device across a communication network, the communication session incorporating the digital certificate in at least one message between the subject device and the other device;
receiving authorization from a legal authority to monitor communications associated with the subject device; and
configuring the communication network to monitor communications thereon associated with the digital certificate responsive to receiving authorization from the legal authority.

2. The method of claim 1, further comprising:
providing the monitored communications to a monitoring agency.

3. The method of claim 2, wherein providing the monitored communications comprises:
encrypting the monitored communications; and
providing the encrypted, monitored communications to the monitoring agency via the World Wide Web.

4. The method of claim 2, further comprising:
configuring the communication network to cease monitoring communications thereon associated with the digital certificate; and
informing the legal authority that the monitored communications have been provided to the monitoring agency.

5. The method of claim 1, wherein the digital certificate is a first digital certificate, and wherein receiving authorization from the legal authority comprises:
receiving an order to monitor communications associated with the subject device, the order comprising a second digital certificate; and
decoding the digital certificate to determine if the order was sent from the legal authority.

6. The method of claim 5, wherein configuring the communication network comprises:
configuring the communication network to monitor communications thereon associated with the digital certificate if the order is determined to have been sent from the legal authority.

7. The method of claim 1, wherein the subject device comprises a mobile terminal or an Internet Protocol (IP) phone.

8. A communication network, comprising:
means for storing a digital certificate on a subject device;
means for establishing a communication session between the subject device and another device across a communication network, the communication session incorporating the digital certificate in at least one message between the subject device and the other device;
means for receiving authorization from a legal authority to monitor communications associated with the subject device; and
means for configuring the communication network to monitor communications thereon associated with the digital certificate responsive to receiving authorization from the legal authority.

9. The communication network of claim 8, further comprising:
means for providing the monitored communications to a monitoring agency.

10. The communication network of claim 9, wherein the means for providing the monitored communications comprises:
means for encrypting the monitored communications; and
means for providing the encrypted, monitored communications to the monitoring agency via the World Wide Web.

11. The communication network of claim 9, further comprising:
means for configuring the communication network to cease monitoring communications thereon associated with the digital certificate; and
means for informing the legal authority that the monitored communications have been provided to the monitoring agency.

12. The communication network of claim 8, wherein the digital certificate is a first digital certificate, and wherein the means for receiving authorization from the legal authority comprises:
means for receiving an order to monitor communications associated with the subject device, the order comprising a second digital certificate; and
means for decoding the digital certificate to determine if the order was sent from the legal authority.

13. The communication network of claim 12, wherein the means for configuring the communication network comprises:
means for configuring the communication network to monitor communications thereon associated with the digital certificate if the order is determined to have been sent from the legal authority.

14. The communication network of claim 8, wherein the subject device comprises a mobile terminal or an Internet Protocol (IP) phone.

15. A computer program product for operating a communication network, comprising:
a computer readable storage medium having computer readable program code embodied therein, the computer readable program code comprising:
computer readable program code configured to store a digital certificate on a subject device;
computer readable program code configured to establish a communication session between the subject device and another device across a communication network, the communication session incorporating the digital certificate in at least one message between the subject device and the other device;
computer readable program code configured to receive authorization from a legal authority to monitor communications associated with the subject device; and
computer readable program code configured to configure the communication network to monitor communications thereon associated with the digital certificate responsive to receiving authorization from the legal authority.

16. The computer program product of claim 15, further comprising:
computer readable program code configured to provide the monitored communications to a monitoring agency.

17. The computer program product of claim 16, wherein the computer readable program code configured to provide the monitored communications comprises:
computer readable program code configured to encrypt the monitored communications; and
computer readable program code configured to provide the encrypted, monitored communications to the monitoring agency via the World Wide Web.

18. The computer program product of claim 16, further comprising:
computer readable program code configured to configure the communication network to cease monitoring communications thereon associated with the digital certificate; and
computer readable program code configured to inform the legal authority that the monitored communications have been provided to the monitoring agency.

19. The computer program product of claim 15, wherein the digital certificate is a first digital certificate, and wherein the computer readable program code configured to receive authorization from the legal authority comprises:
computer readable program code configured to receive an order to monitor communications associated with the subject device, the order comprising a second digital certificate; and
computer readable program code configured to decode the digital certificate to determine if the order was sent from the legal authority.

20. The computer program product of claim 19, wherein the computer readable program code configured to configure the communication network comprises:
computer readable program code configured to configure the communication network to monitor communications thereon associated with the digital certificate if the order is determined to have been sent from the legal authority.
